(19) United States
(12) Patent Application Publication
(10) Pub. No.: US 2006/0265254 A1
(43) Pub. Date: Nov. 23, 2006

(54) AGENCY SERVICE CENTER

(75) Inventors: CARL J. WITKOWSKI, DURYEA, PA (US); JOHN H. RICHARDSON, WILKES-BARRE, PA (US); LISA M. THOMPSON, MOUNTAIN TOP, PA (US); VICTOR T. AMBRUSO, EXETER, PA (US)

Correspondence Address: LACASSE & ASSOCIATES, LLC, 1725 DUKE STREET, SUITE 650, ALEXANDRIA, VA, 22314, US

(73) Assignee: GUARD INSURANCE GROUP, WILKES-BARRE, PA (US)

(21) Appl. No.: 10/908,596

(22) Filed: May 18, 2005

(51) Int. Cl. G06Q 40/00

(52) U.S. Cl. 705/4

(57) ABSTRACT

A client-server system (Agency Service Center) for facilitating business-to-business transactions between an insurance carrier and an independent insurance agency is provided. The system obviates the need for client configuration and is comprised of a web-based interface that provides for self-service online access to a server-side object repository storing insurance policy information. Simultaneous access to a common object repository storing policy information enables a server machine to mirror access granted to a client machine such that users at both computer workstations/terminals are provided an identical view of the accessed data. Also provided are customized commission schedules are generated for a client insurance agency. Also provided is an automated visit process to pending claims and insurance policies upon which activity is required; an insurance carrier sends a message through the Agency Service Center to prompt an agent at an insurance agency to perform the necessary actions on an indicated policy or claim.

### BACKGROUND OF THE INVENTION

The present invention relates generally to the field of insurance policy management and administration. More specifically, the present invention is related to a computer-based system and method for the management of individual insurance policies/entire books of business and the effective management of business relationships with the agent.

### DISCUSSION OF PRIOR ART

It is common practice in the insurance industry to rely on the use of paper mailings to service insurance policies, to provide insurance agents with critical updates to local, state, and federal insurance regulations, and to analyze claim transactions. Drawbacks of a paper-based approach include the cost associated with printing and mailing paper copies, as well as the lack of instantaneous access to vital information. Furthermore, to earn income on smaller insurance policies, the number of “touches” or manual visits on a particular policy must be kept to a minimum, the more time an agent spends on mailing information, updating information, or interacting on the sale/servicing of the policy/client, the less productive the agent becomes and the less income is earned on overall. Thus, there exists a need in the industry to accomplish typical transactions and routine tasks more quickly and less expensively; the amount of paper and the steps involved in manually handling policies must be dramatically reduced such that turnaround times, services, and data analysis are enhanced and straight-thru processing becomes achievable. Therefore, it is necessary to automate activities frequently performed by insurance agencies.

Prior art methods addressing this need and relating to automatic claim adjudication include U.S. Pat. No. 6,343,271 to Peterson et al. The Peterson et al. system provides for automatically adjudicating claims via a claims pre-check module; the module is used to determine if automatic adjudication is possible. If automatic adjudication is not possible, the Peterson et al. reference provide for manual adjudication. However, no mention of commission schedule generation and producer activity tracking is made. Furthermore, Peterson et al. make no mention of submitting, viewing, accessing, or modifying in-force policies or of receiving through the system, critical updates or reminders to service specific policies.

U.S. patent application publication 2002/0069090 to De Grosz et al. provides for an automated application of insurance benefits. Furthermore, De Grosz et al. disclose a commission and revenue-tracking module. The method disclosed by De Grosz et al. is limited in that it does not provide for an automated visit process for reminding an agent when service on a particular policy is required; only benefit application to outstanding claims is mentioned.

U.S. patent application publication 2003/0120588 to Dodd et al. discloses a method to automatically provide point-of-service claim audit and adjudication. Furthermore, Dodd discloses the automatic generation of a hard copy of a processed claim and automatically sends communications to claim representatives if issues arise in the automatic adjudication. The Dodd method is limited in its provision of a claims center that keeps track of visits required of an underwriting agency.

The patent to Jones, WO 02/084520 A1 provides for a method of managing workflow involved in the underwriting of insurance applications. A storage means for policy, claims management data, as well as a means for email interface and report generation is disclosed. However, no mention is made of a zero-client configuration system, nor of an electronic policy and claims tracking or submission method is made.

Whatever the precise merits, features, and advantages of the above cited references, none of them achieves or fulfills the purposes of the present invention.

### SUMMARY OF THE INVENTION

The present invention (hereafter, “Agency Service Center” or ASC) is a client-server system for facilitating and managing the administration of business-to-business transactions between an insurance carrier and an independent insurance agency force for the purpose of underwriting, binding coverage and subsequent servicing of individual policies and managing entire books of business of individual agencies and clusters of agencies. Agency Service Center is comprised of a web-based interface that dynamically generates HTML pages with associated transactions and provides for self-service online access such that insurance agents are able to perform a wide range of insurance-related activities and coordinate comprehensive management activities. Such activities comprise: submitting and tracking a new request for coverage; reviewing reports of recent policy transactions, claims information, and accounting and collections information; generating a producer activity report (PAR) for each insurance agent; generating customized commission schedules for an agency; analyzing claim activity on a particular claim; and generating loss runs and performing loss analysis.

In one embodiment of the ASC, when activity on a pending claim or insurance policy is required, an underwriting agency sends either a priority message or a “tickler” (i.e., an electronic reminder) through the ASC and via fax and/or e-mail to prompt the insurance agency to perform the necessary actions on the indicated policy. Thus, an automated reminder for a visit to the agency service center is provided, whereby an insurance agent need no longer manually schedule reminders to complete transactions on particular policies. In this manner, a client-side insurance agency is able to keep apprised of and ensure compliance with local, state, and federal law and automate various aspects of their business processes. These reminders include, but are not limited to, a summary of significant transactions in the areas of claims (e.g., first reports of injury, loss runs, significant changes in reserves, etc.), finances (e.g., commissions, billing, overdue accounts, audits, etc.), and policy services (renewals, cancellations, endorsements, etc.).

In another embodiment, the Agency Service Center provides for tiered levels of access for each insurance-related activity; each agency customizes privileges for each group performing the activity. A group comprising agents and their appointed administrators is granted permission to view, access, and modify specified information accessible through the Agency Service Center in accordance with the group's profile. In this manner, the agency is able to retain an appropriate amount of control over policy information. If a particular activity is restricted from a particular group, as indicated by permissions associated with that group, navigation to said activity is precluded from the group's view of the Agency Service Center interface.

In yet another embodiment, a “zero-client configuration” (requiring just a browser and an Internet connection) is provided, wherein the client insurance agency is not required to download software to use the ASC. Rather, the client insurance agency connects directly to a server-side object repository that stores information that is used in performing insurance-related activities. Such a direct connection allows both client and server machines to simultaneously access a common object repository storing policy information. In an extended embodiment, a server machine mirrors access granted to a client machine such that users at both the client and the server terminals are viewing the same, simultaneously-accessed data.

### BRIEF DESCRIPTION OF THE DRAWINGS

FIG. 1 illustrates a general system diagram of the Agency Service Center.

FIG. 2 illustrates the Agency Service Center web interface.

FIG. 3a is an interface for searching for policy submissions.

FIG. 3b is a listing of new and renewal accounts.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

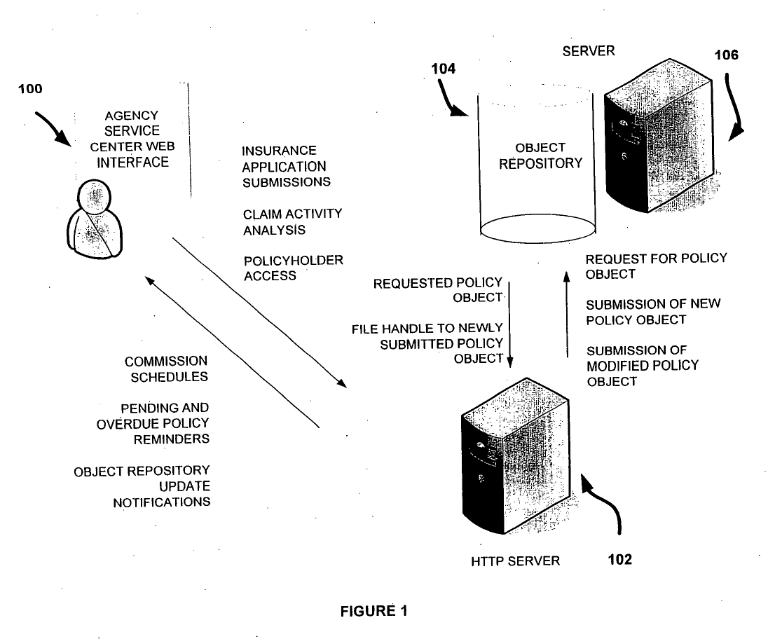

Referring now to FIG. 1, a general system diagram illustrating the Agency Service Center (ASC) is shown. A user at an insurance agency computer workstation uses the ASC's web interface 100 to obtain, over an Internet connection, insurance policy submissions, claims and policy transactions, and access to policyholder information from HTTP server 102. HTTP server 102, forwards the request to object server 104 and server 106. In turn, object server 104 recalls the requested policy object data and returns it to HTTP server 102. HTTP server 102 returns the requested information to submitting agency user manipulating ASC's web interface 100. Based on information requested and received at ASC's web interface 100, an agency is able to determine when activity on a pending claim or insurance policy is required and sends either a priority message or a “tickler” through the ASC to prompt the insurance agency to perform the necessary actions on the indicated policy. In this manner, an automated visit process is provided. Furthermore, in one embodiment, a server machine can mirror access granted to a client machine such that users at both terminals are viewing the same, simultaneously-accessed data.

The ASC is versatile, allowing internal and external users to take advantage of these resources at the office, at a customer's facility, or while on the road. In one embodiment, supporting training is unique due to a proprietary interactive platform, hereafter called “I”-GUARD, which requires no client configuration and enables the set up of remote one-on-one instruction (e.g., a sales representative shares control of the agent's desktop during guided tours).

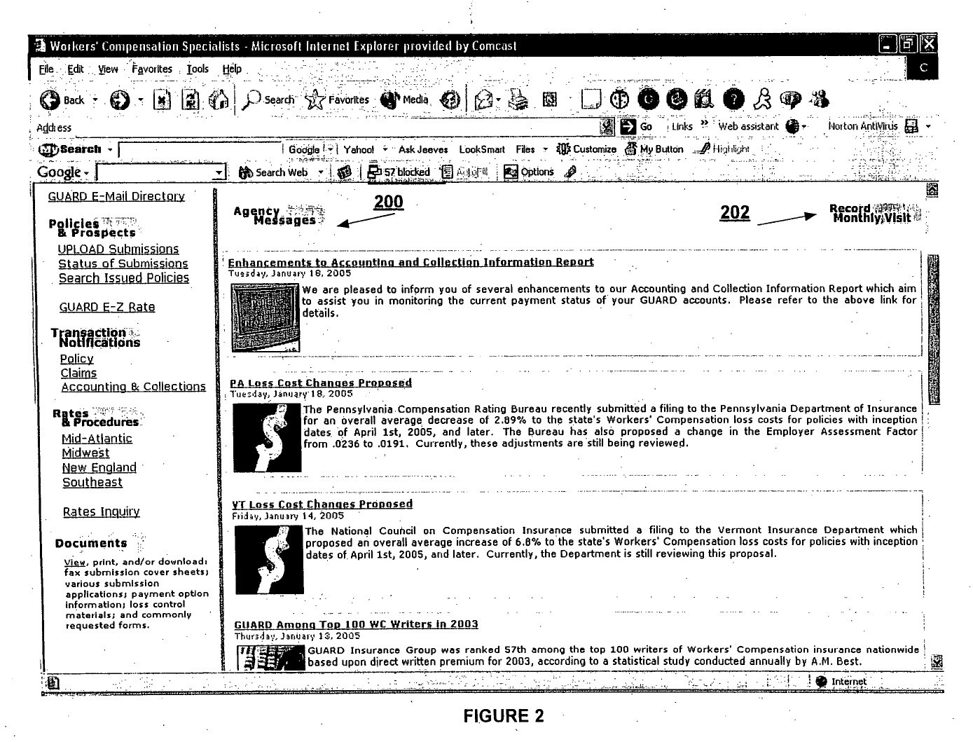

Referring now to FIG. 2, a user at an insurance agency computer workstation is provided with agency messages 200 prompting them to perform the necessary actions on indicated policies. Management tools relieve the agency of the burden of tracking significant events on accounts and serve as an alternative to developing their own internal systems. In one embodiment, a “zero-client configuration” is provided, wherein the client insurance agency is not required to download software to use the ASC. Based on the permissions of the user currently logged in, the appropriate messages and options/permissions are displayed. Users currently logged in are also able to record required monthly visits 202 that provide assurance that insurance agents are at least aware of and are in compliance with state and federal law. Furthermore, the present invention's web interface allows an insurance agency to choose a preferred method of delivery for the notifications—selecting between faxed and/or e-mailed messages. When the latter is chosen, a designated recipient at an insurance agency simply clicks the name or number of a desired policy account to link directly to requested policy documents. In this manner, policy information is accessed on-line, downloaded in portable document format (PDF), and printed for traditional filing, or the agency uses ASC as their document repository.

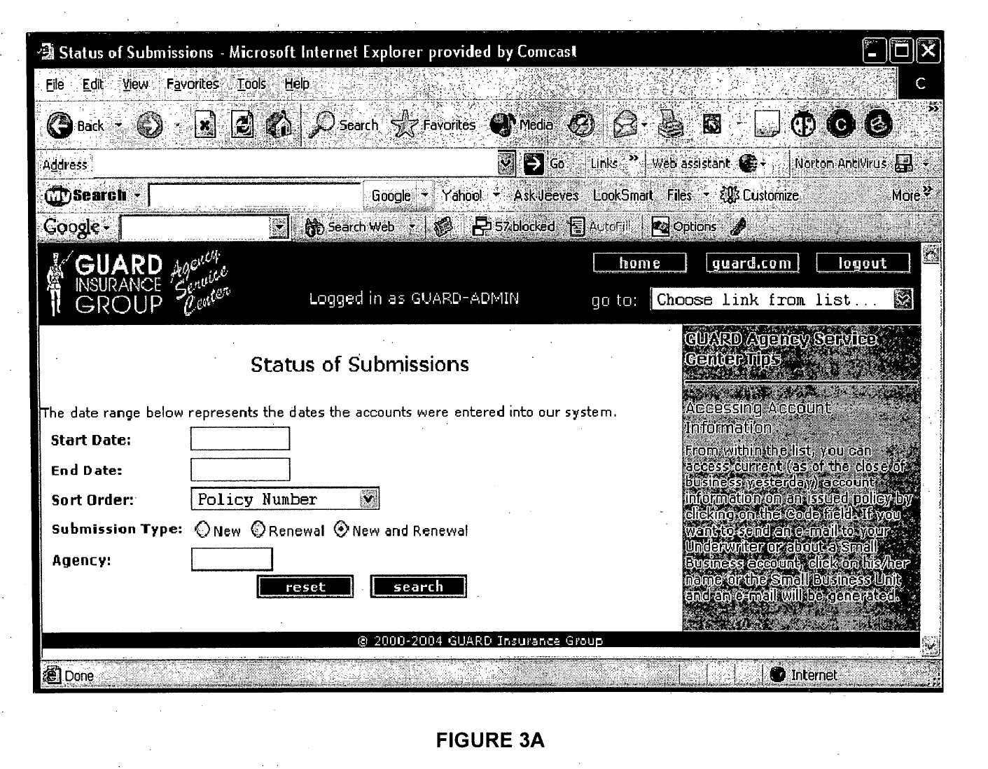

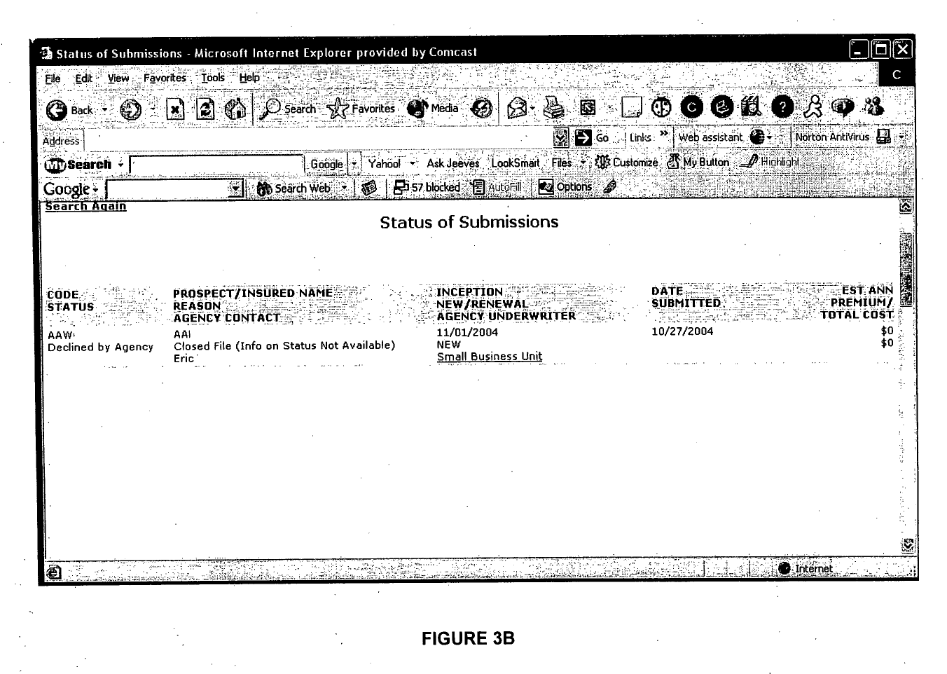

Shown in FIG. 3a is a screenshot of the present invention's ASC illustrating a searchable interface and listing of policy information. Shown in FIG. 3a is an interface for searching for policy submissions; a user enters criteria regarding desired start and end dates for policy coverage. Resulting in FIG. 3b, users are provided with access to a list of all issued policies and are able to develop a customized report that includes only policies which are in-force have expired, or are incepting between specific dates. Users are also able to sort resulting policies by policyholder name or policy number. By preparing lists of all policies which share common inception and expiration dates (or a range of dates), an agent is able to identify those customers due for services, up for renewal, in need of periodic loss runs, about to receive a revised experience modification factor from the state, etc. Each of these activities focuses on ways to support the retention of existing accounts.

Similarly, interfaces are provided for searching for issued policies, particular transactions on a policy, particular transactions on a claim, and accounting and collections information. Based on input provided, the following listings are provided, respectively: in-force policies and insured policyholders, in-force policy transaction specifics, claims transactions, and accounting and collections transactions.

Hence, the present invention's ASC provides for an easy-to-use, web-based application and interface that gives independent agents and brokers the ability to: (1) online management of books of business, (2) submission of account related information via an E-Z Rate component (an on-line, browser-based application that dynamically generates HTML web pages that allows an agency to submit accounts for consideration to the carrier and interact electronically via the application leading to either a quote that is issued with an accompanying proposal for presentation to the prospective insured or a declination of the application), and (3) 24 hours a day, seven days a week, self-service. With the present invention's ASC there is no software installation necessary and the system requirements are minimal (for example, a dial-up or faster Internet connection and moderately current browser).

With the present invention's ASC:

fewer employees are involved in typical transactions;

submissions are processed at a fraction of the time of traditional application processing through an optimized workflow;

paper and postage related to policy processing are reduced because majority of the interactions with producers are paperless;

turnaround times on submissions are reduced;

straight-through processing has been realized on policies; and

implementation costs are reduced.

In the preferred embodiment, the ASC is implemented as a secure site to enhance business-to-business (“b-2-b”) interactions by making available a blend of agency-specific and general information. Qualities such as ease of use, increased efficiency, and cost savings are incorporated while addressing agents' needs in the following areas: submission of accounts; billing and payments; loss control and claims services; and the monitoring of overall agency production, performance, and income.

Although the external members of the distribution network are the primary audience, internal employees are also secondary beneficiaries. The present invention's ability to “impersonate an agent” and see data from a producer's point of view enhances efficiency and effectiveness.

Overall, the web-based platform of the ASC has proven to be versatile, allowing internal and external users to take advantage of these resources at the office, at a customer's facility, or while on the road. Supporting training is unique due to a proprietary interactive platform, hereafter called “I”-GUARD, which requires no client configuration and enables the set up of remote one-on-one instruction (e.g., a sales representative shares control of the agent's desktop during guided tours).

ASC's secure site, which is designed to enhance business-to-business (“b-2-b”) interactions, contains a blend of agency-specific information geared to individual accounts and the agency's overall book of business as well as more general information about our policies and procedures.

Each appointed agency is expected to become a registered ASC user and designates a staff member(s) to serve as the ASC administrator. The ASC administrator is responsible for maintaining basic agency contact data, for setting up additional users (and passwords), and for granting tiered levels of access to specific functions. This system allows each agency to customize privileges and retain the amount of control deemed appropriate. If a particular activity is restricted, navigation to that option is not displayed.

The primary point from which all tools and information can be utilized is the ASC home page, which includes an Agency Messages Center that provides updates on related products, pricing, procedures, and services. Since a user sees only those communications relevant to his/her operation, a significant saving in time is achieved. Priority messages are marked for immediate attention, and extensive archives enable past documents to be researched and reviewed. Commonly requested forms and reference tools are also provided, as well as a tutorial on the functionality of the ASC, a E-Z Rate user's guide, and context-sensitive help screens and “Tips.”

From the home page, users can:

search issued policies by agency-defined criteria, create reports, or navigate to a specific account;

view account information on issued policies and the status of submissions;

perform a rates inquiry;

go to the agency screen to review overall performance by analyzing comprehensive Producer Activity Reports that provide an overview of production and profitability;

submit an application via E-Z Rate;

upload submissions;

gain immediate access to recent activity involving policy management, claims, and/or accounting, commissions, and collections.

Hence, the producer can review extensive information on the activity of a specific account or the agency's total book of business.

Since the ASC serves as an interface to a vast electronic repository of data which had previously been mailed, an attempt has been made to ease the transition from the old paper-based methodologies by providing various faxed and/or e-mailed notifications of information available for retrieval or business transactions that are necessary. Thus, activities of producers are tracked such that producers are reminded to visit the ASC website to see additional details.

Examples of generated reports based on tracked activity include, but are not limited to:

Policy Transactions Report (PTR): PTR identifies all policy issuance, endorsement, cancellation, reinstatement, and final audit activity occurring on a daily basis as well as new messages posted for the agency. Then, a weekly follow-up summary is also sent to recap the week.

Claims Transactions Report (CTR): CTR identifies accounts which require loss runs to be prepared for a variety of reasons as well as recently closed claims.

Accounting and Collections Information Report (ACIR): ACIR is sent whenever a new Commission Statement or Agency Statement has been processed or when a final notice of unpaid audit is sent to the policyholder.

These management tools relieve the agency of the burden of tracking significant events on accounts and serve as an alternative to developing their own internal systems. Furthermore, the agency can choose a preferred method of delivery for the notifications—selecting faxed and/or e-mailed copies. Either way, the designated recipient (or recipients) then has numerous means of accessing documents related to a transaction.

Throughout the ASC, information can be viewed on-line, downloaded in portable document format (PDF), and/or printed for traditional filing. This flexibility enables us to accommodate a wide range of agency preferences and habits.

As mentioned earlier, the present invention's ASC is designed to allow producers to manage both the details of an agency's relationship and an entire book of business. Provided below are some examples of the kinds of activities that can be performed (Note: This non-exhaustive list, while indicative of the capabilities, is not intended to be all inclusive). Via the ASC, agents can:

submit, rate, and track a new request for coverage via E-Z Rate;

review reports of recent policy transactions, claims information, and accounting and collections information;

view specific information about a current transaction;

obtain policy documents on-line before the policyholder receives mailed copies;

view an agency's demographic information;

modify agency address, phone, and fax information;

add new users to the system (administrators only);

generate a Producer Activity Report (PAR), one of the primary tools used to evaluate the overall production, profitability, and efficiency of the operation;

review recent Agency Statements and Commission Statements;

obtain reports of accounts receiving final notices of unpaid audit;

review the agency's current, customized commission schedule;

view a list of all issued policies or develop a customized report that includes only policies which are in-force, have expired, or are incepting between specific dates; then, sort the list by name or policy number;

examine specific information about a policy;

select and print documents such as the policy declarations page (DEC) and any associated endorsements, cancellations, reinstatements, final audits, etc.;

analyze claim activity by studying the results in different categories to identify trends;

generate a standard Loss Run;

produce a Diagnostic Loss Analysis (useful for larger risks);

review billing and payment terms;

confirm the status of premium payments;

view an all-inclusive listing of rates for all class codes and for each carrier filed in a specific state;

search for the rate or rates for a specific carrier and specific inception date;

use “Quick Check” to prescreen prospective accounts;

read the latest news or research past archived information on the Agency Messages Center;

access on-line help via manuals, tutorials, and context-sensitive “Tips”;

download commonly used documents to submit and service accounts;

provide feedback about our services through an easy-to-use on-line form;

e-mail contacts via direct links or through use of an on-line directory.

These tools and capabilities can also be used in combination to accomplish a number of essential administrative functions, some of which are provided below.

If an agent recognizes the advantages of on-line client management, reports on issued policies are used to perform tracking and scheduling. By preparing lists of all policies which share common inception and expiration dates (or a range of dates), an agent can identify those customers due for services, up for renewal, in need of periodic loss runs, about to receive a revised experience modification factor from the state on a regularly scheduled and predictable cycle, etc. Each of these activities focuses on ways to support the retention of existing accounts.

If an agent is conducting a sales campaign, reports on the status of issued policies and submissions are useful in coordinating sales initiatives as well as periodic follow-up activities.

By scheduling and conducting periodic reviews of accounts, a producer can go to a client's page, identify any mid-term transactions that have occurred, check for cash-flow problems that might show up as patterns of late payments, and create a loss run that can be as simple or detailed as necessary. Depending upon the size and complexity of the risk, monthly, quarterly, semi-annual, or annual account reviews of this kind could be beneficial, and a visit to this screen prior to making a client service call can make a difference. The process of collecting the information needed for a renewal sale is also fast and easy.

Also, as mentioned earlier, support training provided on the use of the ASC is unique. In addition to the online documentation already mentioned, each agent receives individualized instruction which can be handled in one of several ways: by visit; by phone; or by use of a proprietary, interactive platform called “I”-GUARD. In the case of the latter solution, one of our regional office sales representatives will set up a teleconference and send a link to our “I”-GUARD site. By accessing the ASC in that way (no special configuration is required), our trainer can actually share control of a computer desktop with the agency staff at a remote location.

The present invention provides many business advantages, some of which are listed below:

Advantages for agents: For companies specializing in writing smaller monoline workers' compensation policies within a highly competitive industry, the number of “touches” (i.e., amount of handling) by agency staff is kept to a minimum to earn income on such accounts. The ASC addresses such factors and increases productivity.

Ease of Use

Increased efficiency: With the ASC, producers are provided with a paperless system that minimizes the “touches” that must occur within the agents' offices. Since all information from multiple disciplines and for multiple accounts is readily available from a single location, no request-response delays occur.

Cost savings: The present invention's ASC provides for significant cost savings.

Fast turnaround: When submitting an application via E-Z Rate, the turnaround time on small policies is reduced. Furthermore, the agent is able to monitor the progress of a submission through the various stages of review, quotation/proposal, and approval. Once a policy of any kind is issued, the producer is notified and can go out to the ASC to view and/or retrieve a copy well in advance of the policyholder's receipt via conventional mail. Furthermore, the characteristics identified above should be found in each of the following content areas: submission of accounts; billing and payments; loss control and claims services; and monitoring of overall agency production, performance, and income.

Electronic Means of Disseminating Information: The present invention's increasingly electronic means of disseminating information are better suited for operations of large agencies that feature alternative organizational structures (such as “clusters”) than traditional paper-based methods, and the present invention's ASC allows data for the various members to be aggregated or viewed separately.

Straight-through processing: Agents input data required to submit a risk for underwriting, thereby placing the carrier in a position to act on the submission without duplicating data entry.

Cost savings—By converting to paperless operations, cost savings is achieved in many ways from reduced personnel requirements and increased productivity to fewer steps needed to complete basic tasks.

In the preferred embodiment, software employed include a Microsoft® Windows™ 2000 Server platform which incorporates: Active Directory (for resource management and security access control); Internet Information Server (IIS™); and SQL Server. In such an implementation, the media accessed by producers on the ASC are made available via a proprietary implementation of two additional Microsoft® products: Active Data Objects (ADO) as the database management component and Distributed File System to manage the proprietary media repository.

On the client side, Internet Explorer 5.0 or later is required because the ASC requires no configuration and was developed to function acceptably in a thin-client environment.

An extensible, scalable architecture has been employed to build the present invention's infrastructure. All web services are designed to run on one or more clustered servers which request connections to a cluster of servers (such as Microsoft® SQL database servers) for data collection and then communicate with a back-end server to allow real-time updates of our remaining legacy system. The ASC and E-Z Rate are fully integrated with an insurance system that has been implemented to take advantage of existing web-based technology.

The Agency Service Center is a unique product that is both an n-tier implementation and a browser-based application. A new proprietary SDLC (System Development Life Cycle) was employed that utilizes the Delphi Object Pascal language to create WIN-CGI Exes that interact with Microsoft's IIS and a series of Microsoft SQL Server databases and proprietary, internally developed SQL stored procedures. A complex series of HTML-based web pages are rendered on-the-fly and served to the client with embedded JavaScript for complex functions.

In one implementation, the development methodology used is a combination of the Unified Process, RAD, and Extreme Programming (XP) processes. The systems were designed using UML sequence diagrams and database entity relationship diagrams. Delphi® (a product of Borland) features an integrated development environment that allowed for rapid completion and testing of web-based applications. Delphi's ADO database connectivity components allowed for rapid development of the multi-tiered Transact-SQL command architecture.

Additionally, the present invention provides for an article of manufacture comprising computer readable program code contained within implementing one or more modules to automate claim adjudication and insurance policy services. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) automating visit processes for claim adjudication and insurance policy transactions; (b) generating customized commission schedules and producer activity reports (PAR); and (c) mirroring at a server-side terminal, client-side actions performed upon data stored in an object repository at a client-side.

### CONCLUSION

A system has been shown in the above embodiments for the effective implementation of an agency service center. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, subject matter of information operated upon, or specific computing hardware.

The above enhancements are implemented in various computing environments. For example, the present invention may be implemented on a multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of database or client-server programming.

What is claimed is:

1. A system of tracking and managing real-time agent access to a repository storing insurance policy and policyholder information; said system comprising:
means for rendering a web-based interface at an agent terminal, said web-based interface used to access and modify insurance policy related information stored in said repository;
means for submitting, rating, and tracking a new request for coverage;
means for generating a report based on tracked activity, said reports comprising any of, or a combination of: a policy transaction report, a claims transaction report, or a accounting and collections information report;
means for storing said generated reports in said repository; and
means for notifying an agent and reminding said agent to access said web-based interface for said generated reports.

2. A system of tracking and managing real-time agent access, as per claim 1, wherein said policy transactions report identifies policy issuance, endorsement, cancellation, reinstatement, and final audit activity occurring on a daily basis as well as new messages posted for the agency.

3. A system of tracking and managing real-time agent access, as per claim 1, wherein said claims transactions report identifies accounts which require loss runs to be prepared for a variety of reasons as well as recently closed claims.

4. A system of tracking and managing real-time agent access, as per claim 1, wherein said accounting and collections information report is sent whenever a new commission statement or agency statement has been processed or when a final notice of unpaid audit is sent to the policyholder.

5. A system of tracking and managing real-time agent access, as per claim 1, wherein said notification is via an electronic tickle message.

6. A system of tracking and managing real-time agent access, as per claim 1, wherein said notification is a facsimilie notification.

7. A system of tracking and managing real-time agent access, as per claim 1, wherein said access is comprised of: searching and sorting issued policies.

8. A system of tracking and managing real-time agent access, as per claim 7, wherein said issued policies are search by either of: inception or expiration date range.

9. A system of tracking and managing real-time agent access, as per claim 7, wherein said issued policies are sorted by any of: name of insured member, policy number, and expiration date.

10. A system of tracking and managing real-time agent access, as per claim 1, wherein said reports further comprises: agency usage of said interface, agent monthly visitations, policy transactions, claims transactions, and commissions schedules.

11. A system of tracking and managing real-time agent access, as per claim 1, wherien said system further comprises means for impersonating an agent to provide one-on-one instructions in support training.

12. A system for dynamically coordinating and facilitating insurance-related policy functions, said system comprising:
agent access to any of: insurance policy, policyholder account, and claim activity information;
new and renewed insurance policy account submissions claim activity analysis and insurance policy transactions;
a means of monitoring said agent access; said monitoring based on agent privileges and said agent access permitted by said agent privileges; and
a direct communication of any of: pending and overdue insurance policy calculations based on said agent access.

13. A method of tracking and managing real-time agent access to a repository of insurance policy and policyholder information; said method comprising:
connecting over a communications link to an agent computer workstation/terminal to a server storing said repository;
performing insurance-related functions comprising accessing, modifying, and analyzing information stored in said repository at said agent computer workstation/terminal and submitting new insurance applicant information;
analyzing either of: policy or claim transactions, based on said insurance-related activities performed;
sending, over said communication link, said analysis of either of said policy or claim transactions; and
dynamically modifying messages to be sent over said communications link; said message comprising a lists of future insurance-related functions to be performed by said agent.

14. A method of tracking and managing real-time agent access to a repository storing insurance policy and policyholder information; said method comprising:
rendering a web-based interface at an agent terminal, said web-based interface used to access and submit, rate, track, and modify insurance policy related information stored in said repository;
generating a report based on tracked activity, said reports comprising any of, or a combination of: a policy transaction report, a claims transaction report, or a accounting and collections information report;
storing said generated reports in said repository; and
notifying an agent and reminding said agent to access said web-based interface for said generated reports.

15. A method of tracking and managing real-time agent access, as per claim 14, wherein said policy transactions report identifies policy issuance, endorsement, cancellation, reinstatement, and final audit activity occurring on a daily basis as well as new messages posted for the agency.

16. A method of tracking and managing real-time agent access, as per claim 14, wherein said claims transactions report identifies accounts which require loss runs to be prepared for a variety of reasons as well as recently closed claims.

17. A method of tracking and managing real-time agent access, as per claim 14, wherein said accounting and collections information report is sent whenever a new commission statement or agency statement has been processed or when a final notice of unpaid audit is sent to the policyholder.

18. A method of tracking and managing real-time agent access, as per claim 14, wherein said notification is via an electronic tickle message.

19. A method of tracking and managing real-time agent access, as per claim 14, wherein said notification is a facsimilie notification.

20. A method of tracking and managing real-time agent access, as per claim 14, wherein said access is comprised of: searching and sorting issued policies.

21. A method of tracking and managing real-time agent access, as per claim 20, wherein said issued policies are search by either of: inception or expiration date range.

22. A method of tracking and managing real-time agent access, as per claim 20, wherein said issued policies are sorted by any of: name of insured member, policy number, and expiration date.

23. A method of tracking and managing real-time agent access, as per claim 14, wherein said reports further comprises: agency usage of said interface, agent monthly visitations, policy transactions, claims transactions, and commissions schedules.

24. A method of tracking and managing real-time agent access, as per claim 14, wherien said method further comprises the step of impersonating an agent to provide one-on-one instructions in support training.
